(19) United States
(12) Patent Application Publication
(10) Pub. No.: US 2013/0339689 A1
(43) Pub. Date: Dec. 19, 2013

(54) LATER STAGE READ PORT REDUCTION

(71) Applicants: Srikanth T. Srinivasan, Portland, OR (US); Chia Yin Kevin Lai, Portland, OR (US); Bambang Sutanto, Hillsboro, OR (US); Chad D. Hancock, Hillsboro, OR (US)

(72) Inventors: Srikanth T. Srinivasan, Portland, OR (US); Chia Yin Kevin Lai, Portland, OR (US); Bambang Sutanto, Hillsboro, OR (US); Chad D. Hancock, Hillsboro, OR (US)

(21) Appl. No.: 13/993,546

(22) PCT Filed: Dec. 29, 2011
(86) PCT No.: PCT/US11/67944

§ 371 Date: Jun. 12, 2013

(51) Int. Cl. G06F 9/38

(52) U.S. Cl. CPC G06F 9/3867
USPC 712/233

(57) ABSTRACT

In some implementations, a register file has a plurality of read ports for providing data to a micro-operation during execution of the micro-operation. For example, the micro-operation may utilize at least two data sources, with at least one first data source being utilized at least one pipeline stage earlier than at least one second data source. A number of register file read ports may be allocated for executing the micro-operation. A bypass calculation is performed during a first pipeline stage to detect whether the at least one second data source is available from a bypass network. During a subsequent second pipeline stage, when the at least one second data source is detected to be available from the bypass network, the number of the read ports allocated to the micro-operation may be reduced.

### TECHNICAL FIELD

This disclosure relates to the technical field of microprocessors.

### BACKGROUND ART

A register file is an array of storage locations (i.e., registers) that may be included as part of a central processing unit (CPU) or other digital processor. For example, a processor may load data from a larger memory into registers of a register file to perform operations on the data according to one or more machine-readable instructions. To improve speed of the register file, the register file may include a plurality of dedicated read ports and a plurality of dedicated write ports. The processor uses the read ports for obtaining data from the register file to execute an operation and uses the write ports to write data back to the register file following execution of an operation. However, a register file that has fewer read ports may consume less power and less on-chip real estate than a register file having a larger number of read ports. Accordingly, the number of read ports that are available at any one time may be limited.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example framework of a system able to perform later stage read port reduction according to some implementations.

FIG. 2 illustrates an example pipeline including later stage read port reduction according to some implementations.

FIG. 3 illustrates an example of multiple pipelines executing concurrently and including an operand bypass based on later stage read port reduction according to some implementations.

FIG. 4 is a block diagram illustrating an example process for later stage read port reduction according to some implementations.

FIG. 5 illustrates an example processor architecture able to perform later stage read port reduction according to some implementations.

FIG. 6 illustrates an example architecture of a system to perform later stage read port reduction according to some implementations.

### DETAILED DESCRIPTION

This disclosure includes techniques and arrangements for performing read port reduction during execution of an operation. For example, a register file may include a plurality of read ports for providing access to data during execution of machine-readable instructions, such as micro-operations. When a particular micro-operation is scheduled for execution, a plurality of read ports may be assigned as data sources to provide operands for executing the micro-operation. Furthermore, a pipeline for execution of the micro-operation may include a bypass calculation to detect whether one or more of the operands will be available through a bypass network. When an operand will be available through the bypass network, the corresponding read port allocated as the data source for that operand may be released and the operand is obtained from the bypass network during execution of the operation. The released read port may be reallocated for use in executing another micro-operation, thus improving the efficiency of the processor.

According to some implementations, when a micro-operation that uses at least two data sources is scheduled for execution, logic may detect that at least one first data source of the micro-operation is utilized during execution of the micro-operation at least one pipeline stage earlier than at least one second data source of the micro-operation. Thus, during a first clock cycle or pipeline stage, a bypass calculation may be performed to detect whether the at least one second data source is available from a bypass network. During a subsequent second pipeline stage, when the bypass calculation indicates that the at least one second data source is available from the bypass network, the at least one second data source from the bypass network may be utilized to reduce the number of read ports allocated to execute the micro-operation. Since the read port reduction for the at least one second data source is performed after completion of the bypass calculation in a previous pipeline stage, the read port reduction may be applied with certainty to the one or more second data sources. Additionally, because the read port reduction for the at least one second data source is performed concurrently with another step of the micro-operation, no additional pipeline stages are required for performing the read port reduction stage for the at least one second data source.

Additionally, in some examples, there may be at least one third data source that is utilized at least one pipeline stage after the at least one second data source and at least two pipeline stages after the at least one first data source. Therefore, read port reduction for the at least one third data source may be performed at a later pipeline stage than the read port reduction for the at least one second data source, which may be performed at a later pipeline stage than the read port reduction for the at least one first data source. Accordingly, respective bypass calculations may be performed in three separate stages for the first data source(s), the second data source(s) and the third data sources. Alternatively, in some examples, the bypass calculation for the second data source(s) and the third data source(s) may be performed in the same pipeline stage.

Some implementations are described in the environment of a register file and the execution of micro-operations within a processor. However, the implementations herein are not limited to the particular examples provided, and may be extended to other types of operations, register files, processor architectures, and the like, as will be apparent to those of skill in the art in light of the disclosure herein.

### Example Framework

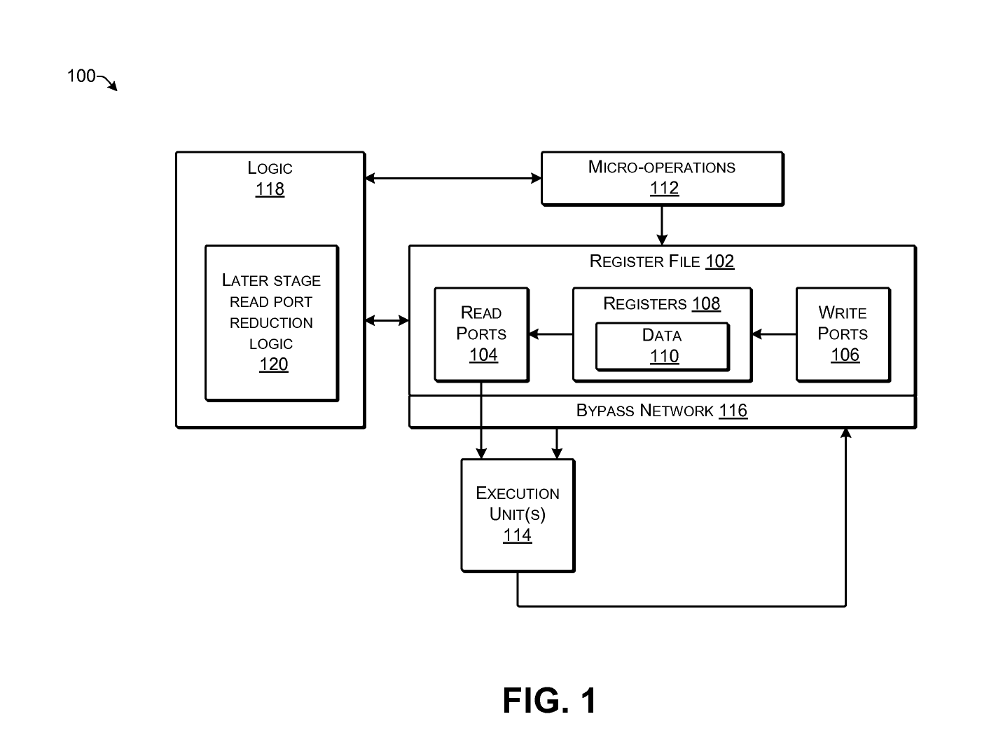

FIG. 1 illustrates an example framework of a system 100 including a register file 102 having a plurality of read ports 104, a plurality of write ports 106, and a plurality of registers 108. In some implementations, the system 100 may be a portion of a processor, a CPU, or other digital processing apparatus. The read ports 104 may be used to access data 110 maintained in the registers 108 during execution of one or more micro-operations 112 on one or more execution units 114. The write ports 106 may be used to write back data 110 to the registers 108 following the execution of the one or more micro-operations 112 on the one or more execution units 114.

A bypass network 116 may be associated with the register file 102 and the execution units 114 for enabling operands to be passed directly from one micro-operation to another. In some implementations, the bypass network may be a multilevel bypass network including, for example, three separate bypass channels or bypass levels typically referred to as bypass levels L0, L1and L2. For example, bypass level LO may be used to pass an operand to a pipeline that is executing one pipeline stage behind an instant pipeline; bypass level L1 may be used to pass an operand to a pipeline that is executing two pipeline stages behind an instant pipeline; and bypass level L2 may be used to pass an operand to a pipeline that is executing three pipeline stages behind an instant pipeline.

A logic 118 may provide control over execution of micro-operations 112 and allocation of read ports 104 for execution of particular micro-operations 112. The logic 118 may be provided by microcontrollers, microcode, one or more dedicated circuits, or any combination thereof Further, the logic 118 may include multiple individual logics to perform individual acts attributed to the logic 118 described herein, such as a first logic, a second logic, and so forth. Additionally, according to some implementations herein, the logic 118 may include a later stage read port reduction logic 120 that identifies data sources that are used subsequently to other data sources and which performs read port reduction with respect to those later-used sources. For example, when a micro-operation 112 that uses multiple data sources is scheduled for execution, the logic 118 may detect that at least one first data source of the micro-operation is utilized at least one clock cycle or pipeline stage earlier than at least one other second data source of the micro-operation. Thus, a bypass calculation may be performed during the same pipeline stage as read port reduction for the at least one first data source to detect whether the at least one second data source is available from a bypass network. During a subsequent second pipeline stage, read port reduction for the at least one second data source may be executed based on the bypass calculation performed during the earlier pipeline stage. Through the second pipeline stage read port reduction, a read port allocated to the at least one second data source may be released from the current micro-operation and reassigned to a different micro-operation when the bypass calculation shows that the at least one second data source is available from the bypass network. Another step of the micro-operation, such as a register file read for the at least one first data source, may also be performed contemporaneously during this subsequent second pipeline stage, and thus performing the read port reduction for the at least one second data source does not consume an additional pipeline stage.

### Example Pipelines

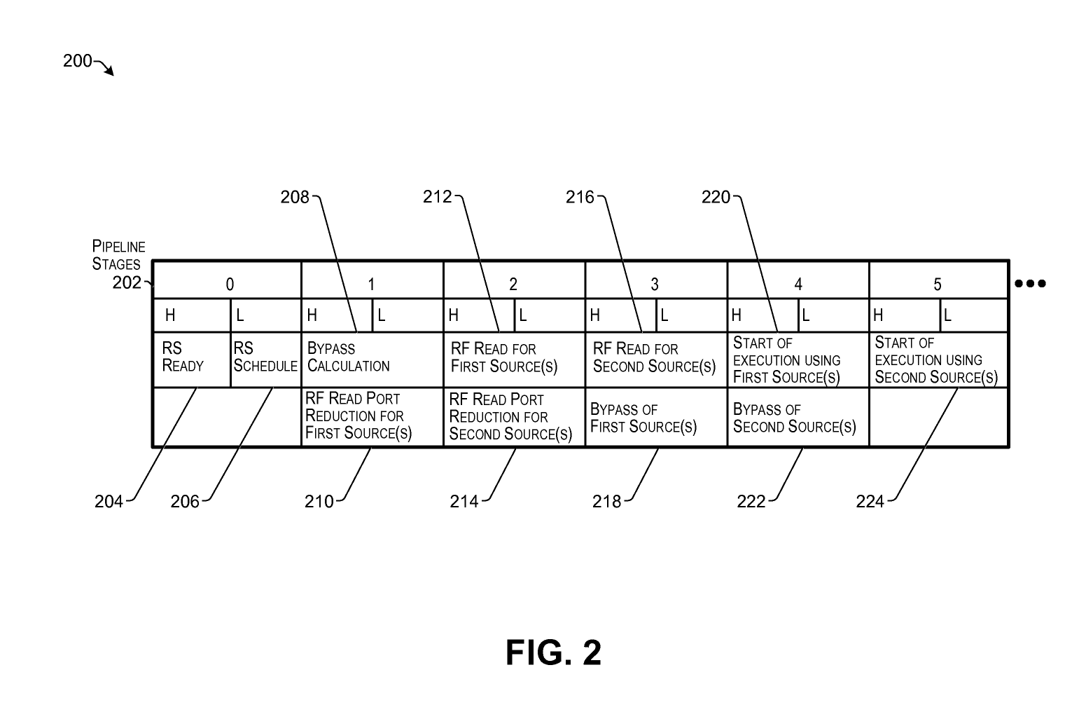

FIG. 2 illustrates an example pipeline 200 showing execution of a micro-operation that may implement later stage read port reduction according to some implementations herein. The pipeline 200 is a pipeline for a complex or compound micro-operation that utilizes at least two data sources sequentially when executing the micro-operation. For example, at least one of the data sources used during the micro-operation might be accessed or utilized during a first pipeline stage while another of the data sources used during the micro-operation might be accessed or utilized during a subsequent pipeline stage. Several nonlimiting examples of such micro-operations include a fused-multiply-add (FMA) micro-operation, a string-and-text-processing-new-instructions (STTNI) micro-operation, and a dot-product-of-packed-single-precision-floating-point-value (DPPS) micro-operation.

As one nonlimiting example, during execution of the FMA micro-operation, two operands from two data sources are used initially during a multiplication step and then the product of the multiplication step is added to a third operand from a third data source to produce the output. Consequently, the FMA micro-operation utilizes three data sources to obtain the three operands for executing the FMA micro-operation, but the third operand is utilized during a pipeline stage that is executed subsequently to a pipeline stage that utilizes the first two operands. Accordingly, when the FMA micro-operation is scheduled for execution, three register file read ports 104 are allocated to enable the FMA micro-operation to obtain the three operands for executing the micro-operation. One or more of these three read ports 104 may be subsequently released and reallocated to another micro-operation if the FMA micro-operation is able to obtain one or more of the three operands from the bypass network 116. Because there are a limited number of read ports 104 available, freeing up even a single read port 104 can contribute significantly to overall processing efficiency for enabling a plurality of micro-operations to be executed in parallel. Accordingly, the pipeline 200 includes pipeline stages for bypass calculation and read port reduction.

The pipeline 200 includes a plurality of pipeline stages 202 numbered consecutively starting from zero. In some implementations, each pipeline stage 202 may correspond to one clock cycle; however, in other implementations, this may not necessarily be the case. Furthermore, each pipeline stage 202 may include a high phase and a low phase, as is known in the art. At pipeline stage 0, the micro-operation is initiated in the high phase, as indicated at 204, and any other related micro-operations to be executed subsequently and/or in parallel may be scheduled or initiated in the low phase, as indicated at 206.

At pipeline stage 1, as indicated at 208, a bypass calculation may be performed to detect whether one or more of the operands used by the micro-operation can be obtained from the bypass network 116. During bypass calculation, the logic may refer to any concurrently executing micro-operations to detect whether one or more of the operands required for the instant micro-operation will be available in time to be utilized by the instant micro-operation.

Furthermore, read port reduction for one or more first data sources may also take place during pipeline stage 1, as indicated at 210. For example, the one or more first data sources may provide operands that are used earlier in the pipeline 200 than operands obtained from one or more second data sources that are used later in the pipeline 200. Typically the bypass calculation needs to be completed before read port reduction may be performed. However, depending on the type of operation being executed and the type of data source, read port reduction may sometimes be performed during pipeline stage 1 for the first data sources while the bypass calculation is also being performed. For example, in the case in which there is a single first data source, if that single first data source of the micro-operation was not ready the previous cycle and becomes ready during the current cycle, then the micro-operation can get an L0 bypass from a concurrently executing pipeline. This information (“not ready last cycle but ready this cycle”) for single source micro-operations from pipeline stage 0 can be used by the logic 118 to perform read port reduction in pipeline stage 1 when there is only a single first source. However, for micro-operations that do not use a single first data source, the “not ready last cycle but ready this cycle” information does not convey which of the first data sources can be obtained from the bypass network 116. In other words, when only a single first data source is being used initially for a first portion of a compound micro-operation, there can be certainty that the single first data source obtained from the bypass network 116 is the proper data source. One the other hand, if there is more than a single first data source, then read port reduction with respect to the first data sources typically cannot be performed because the complete bypass information is not known. Hence, when multiple first operands are required during a first execution stage of a compound micro-operation, there will typically not be any read port reduction at pipeline stage 1 since the bypass calculation is also executed in pipeline stage 1. An exception exists, however, that if one of the first data sources is a constant, then read port reduction may be possible based on the “not ready last cycle but ready this cycle” information.

At pipeline stage 2, a register file read step may be executed for the one or more first sources that will not be obtained from the bypass network 116, as indicated at 212. Accordingly, in the case in which there are two first data sources, then the two first operands are obtained from the register file read ports 104 in pipeline stage 2. For example, in the case of an FMA micro-operation, the two operands that will be used in the multiplication step can be obtained from the register file read ports 104 during pipeline stage 2.

Also during pipeline stage 2, read port reduction may be performed for the one or more second data sources, as indicated at 214. For example, because the bypass calculation was completed during the previous pipeline stage 1, full bypass information is now available in pipeline stage 2 for detecting whether a particular second data source is available from the bypass network 116. If so, the read port 104 assigned to the particular second data source may be released and reassigned or reallocated to a different micro-operation. For example, the logic 118 may reallocate the read port to a different micro-operation that is next scheduled for execution, and thus, in some examples, execution of another micro-operation may begin using the released read port 104.

During pipeline stage 3, a register file read for the one or more second sources may be executed, as indicated at 216, when one or more of the second sources will not be obtained from the bypass network 116. Furthermore, if one of the first data sources will be obtained from the bypass network, the corresponding operand may be obtained from the bypass network during pipeline stage 3, as indicated at 218.

During pipeline stage 4, execution using the one or more first sources is initiated, as indicated at 220. For example, in the case of the FMA micro-operation described above, the multiplication step may be carried out in pipeline stage 4. Furthermore, if one or more of the second data sources will be obtained from the bypass network, the corresponding operand may be obtained during pipeline stage 4, as indicated at 222.

During pipeline stage 5, execution using the one or more second sources may be initiated, as indicated at 224. For example, in pipeline stage 5, in the case of the FMA micro-operation described above, the product of the multiplication step executed in pipeline stage 4 is added to the operand obtained from the second data source. Furthermore, additional pipeline stages may be executed beyond pipeline stage 5, such as for performing a writeback to a register 108 through a write port 106, or the like.

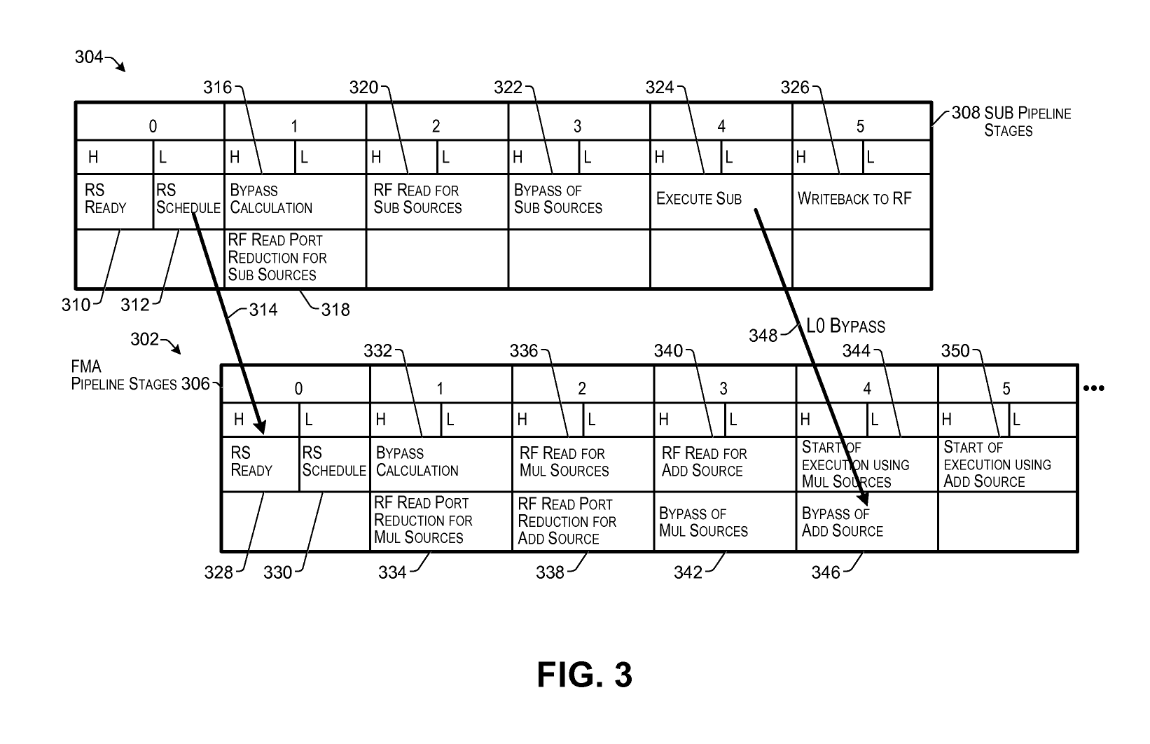

FIG. 3 illustrates a nonlimiting example of providing an operand through the bypass network 116 in conjunction with later stage read port reduction. In the example of FIG. 3, pipeline 302 illustrates stages of execution of the FMA micro-operation, while pipeline 304 illustrates stages of execution of a SUB (subtraction) micro-operation that commenced one clock cycle (or one pipeline stage) earlier than FMA pipeline 302. FMA Pipeline 302 includes a plurality of FMA pipeline stages 306, starting at stage 0, while SUB pipeline 304 includes a plurality of SUB pipeline stages 308, also starting at stage 0.

In the illustrated example, with respect to SUB pipeline 304, SUB pipeline stage 0 includes an initial ready step in the high phase as indicated at 310, and a scheduler step in the low phase, as indicated at 312. For example, suppose that the result of the SUB micro-operation will be used by the FMA micro-operation as the third operand that is added to the product of the multiplication step of the FMA micro-operation. Accordingly, as indicated by arrow 314, when the SUB micro-operation is initiated in SUB pipeline stage 0, the initiation of the FMA micro-operation may be scheduled to begin as soon as the next clock cycle or pipeline stage.

At SUB pipeline stage 1 of the SUB micro-operation, a bypass calculation may be performed, as indicated at 316. For example, the bypass calculation may be used to detect one or more subsequent operations that will receive a bypass of the output of the SUB operation. Furthermore, also at SUB pipeline stage 1, register file read port reduction may be performed, as indicated at 318, to detect whether one or more of the data sources for the SUB operation may be obtained through the bypass network from a previously executing micro-operation (not shown in FIG. 3). As discussed above, if one of the SUB operands is a constant, then it may be possible to perform read port reduction for the other SUB data source in some situations.

At SUB pipeline stage 2, if bypass is not available, the SUB operands are obtained from reading the register file data sources through the assigned read ports, as indicated at 320. At SUB pipeline stage 3, if bypass of one of the SUB sources is available, the operand is obtained from the bypass network during this stage, as indicated at 322. At SUB pipeline stage 4, the subtraction operation is executed as indicated at 324. At SUB pipeline stage 5, the result of the subtraction operation is written back to the register file through a write port 106.

With respect to the FMA pipeline 302, at FMA pipeline stage 0 the pipeline is initiated, as indicated at 328, and any subsequent related operations are scheduled, as indicated at 330. At FMA pipeline stage 1, the bypass calculation is performed, as indicated at 332, and register file read port reduction for the multiplication (Mul) data sources is performed, as indicated at 334. As mentioned above, because there are two Mul data sources, typically read port reduction would not be possible at this point unless one of the multiplication operands is a constant.

At FMA pipeline stage 2, as indicated at 336, the register file read ports are read to obtain the multiplication operands from the read ports allocated as the Mul data sources. Also at FMA pipeline stage 2, as indicated at 338, read port reduction may be performed for the Add data source. For example, the bypass calculation 332 performed in FMA pipeline stage 1 will indicate that the Add operand for the FMA micro-operation will be available from the concurrently executing SUB micro-operation. Accordingly, at FMA pipeline stage 2, register file read port reduction may take place by releasing, reallocating, reassigning, or otherwise making available for use by another operation, the read port 104 assigned to be the data source of the Add operand for the FMA micro-operation. In other words, since the Add operand of the FMA micro-operation can be obtained from the bypass network 116, the read port 104 assigned for providing the Add operand can be released and reassigned to another micro-operation that is ready to be executed.

At FMA pipeline stage 3, if read port reduction was not available for the Add data source, then the Add operand would be obtained from reading a register file read port, as indicated at 340. Also at FMA pipeline stage 3, if one of the Mul data sources can be obtained from the bypass network, it is obtained during this pipeline stage, as indicated at 342.

At FMA pipeline stage 4, the multiplication operation is performed using the multiplication operands obtained from the Mul data sources, as indicated at 344. Furthermore, as indicated at 346, the Add operand is obtained from the bypass network as an L0 bypass provided as the result of the executed addition step on SUB pipeline 304, as indicated by arrow 348. In this case, the bypass network 116 serves as the data source for the Add operand. Thus, the SUB pipeline 304 is a producer and the FMA pipeline 302 is a consumer (i.e., the SUB pipeline produces an operand that is consumed by the FMA pipeline). In some cases, a consumer may use multiple operands produced by multiple producers. For example, a first producer may pass a first operand to the consumer through the LO bypass network, while a second producer may pass a second operand to the consumer through the L1 bypass network, and so forth.

At FMA pipeline stage 5, as indicated at 350, execution of an addition operation is performed using the Add operand obtained from the bypass network 116 and the product of the multiplication operation executed in FMA pipeline stage 4. Furthermore, one or more additional FMA pipeline stages (not shown) may be included in pipeline 302, such as a writeback operation or the like.

In addition, the example of FIG. 3 includes two first data sources for the Mul operation and one second data source for the Add operation, with the second data source being utilized at least one pipeline stage subsequent to the two first data sources. In some examples (not shown in FIG. 3), a third data source may be utilized at least one pipeline stage after the second data source. As one nonlimiting example, a micro-operation may include a third data source for a SUB-like operation that is conditionally blended with the result of the Add operation in the FMA micro-operation based on masking. Accordingly, the read port reduction for the at least one third data source may be performed at least one pipeline stage after the read port reduction for the at least one second data source and at least two pipeline stages after the read port reduction for the at least one first data source. Alternatively, in some examples, the read port reduction for the second data source(s) and the third data source(s) may be performed during the same pipeline stage. Similarly, the bypass calculations for the third data source(s) may be performed at a later pipeline stage than for the second data source(s), or during the same pipeline stage. Other variations will also be apparent to those of skill in the art in light of the disclosure herein.

### Example Process

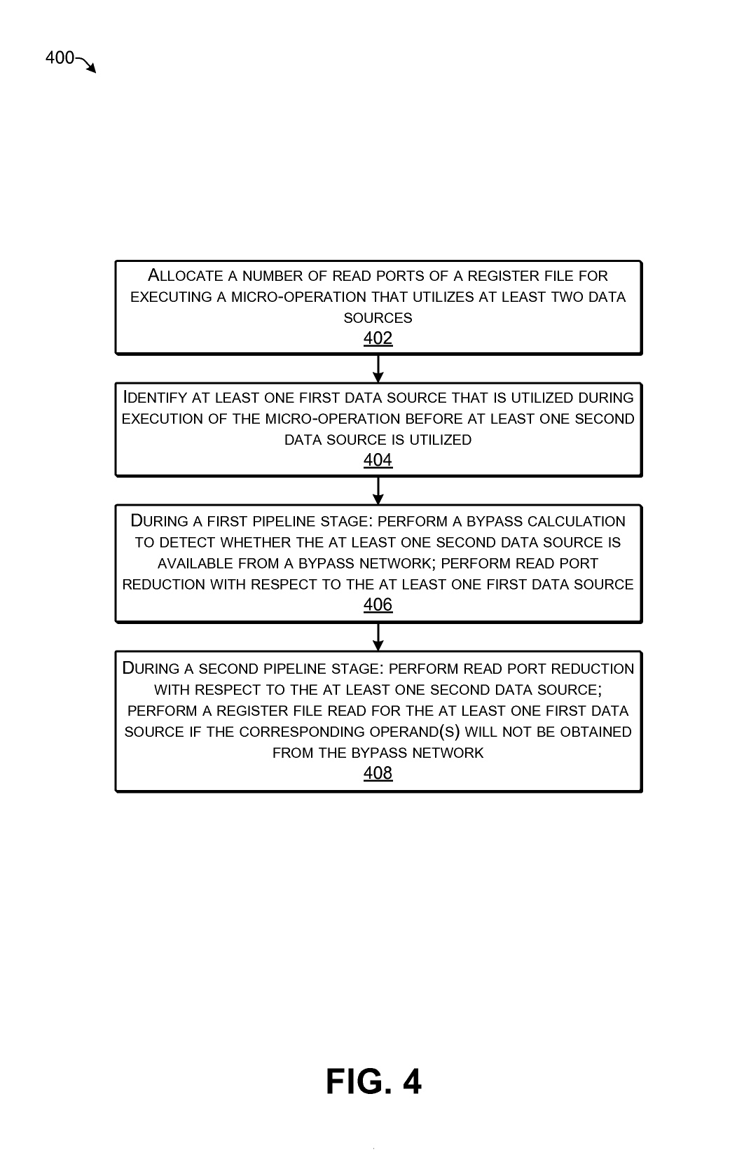

FIG. 4 illustrates an example process for implementing the later stage read port reduction techniques described herein. The process is illustrated as a collection of operations in a logical flow graph, which represents a sequence of operations, some or all of which can be implemented in hardware, software or a combination thereof In the context of software, the blocks represent computer-executable instructions stored on one or more computer-readable media that, when executed by one or more processors, perform the recited operations. Generally, computer-executable instructions include routines, programs, objects, components, data structures and the like that perform particular functions or implement particular abstract data types. The order in which the operations are described is not intended to be construed as a limitation. Any number of the described blocks can be combined in any order and/or in parallel to implement the process, and not all of the blocks need be executed. For discussion purposes, the process is described with reference to the frameworks, architectures, apparatuses and environments described in the examples herein, although the process may be implemented in a wide variety of other frameworks, architectures, apparatuses or environments.

FIG. 4 is a flow diagram illustrating an example process 400 for later stage read port reduction according to some implementations. The process 400 may be executed by the logic 118, which may include suitable code, instructions, controllers, dedicated circuits, or combinations thereof.

At block 402, the logic 118 allocates a number of read ports of a register file for use during execution of a micro-operation that utilizes at least two data sources. For example, the logic may allocate a read port for each data source that will be utilized during execution of the micro-operation.

At block 404, the logic 118 identifies at least one first data source that is utilized during execution of the micro-operation before at least one second data source is utilized. For example, in some implementations, the micro-operation may be a compound micro-operation that utilizes one or more first data sources during a particular stage of a pipeline, and utilizes one or more second data sources during a subsequent stage of the pipeline. In some examples, the logic may recognize the micro-operation as a member of a class or type of micro-operation that is subject to later stage read port reduction.

At block 406, during a first pipeline stage, the logic 118 performs a bypass calculation to detect whether the at least one second data source is available from a bypass network. Additionally, in some implementations, during the first pipeline stage, the logic 118 may perform read port reduction with respect to the at least one first data source to detect whether a read port assigned to the at least one first data source may be released and reallocated to another micro-operation.

At block 408, during a second pipeline stage, subsequent to the first pipeline stage, the logic 118 performs read port reduction with respect to the at least one second data source. For example, the logic 118 may detect whether the at least one second data source is available from the bypass network based on the bypass calculation performed during the first pipeline stage. When the at least one second data source is available from the bypass network, the number of read ports allocated to execute the micro-operation may be reduced. For example, the logic 118 may release at least one read port assigned to the at least one second data source and allocate the released read port to a different micro-operation. Additionally, also during the second pipeline stage, a register file read may be performed for the at least one first data source if the corresponding operand(s) will not be obtained from the bypass network.

The example process described herein is only one nonlimiting example of a process provided for discussion purposes. Numerous other variations will be apparent to those of skill in the art in light of the disclosure herein. Further, while the disclosure herein sets forth several examples of suitable frameworks, architectures and environments for executing the techniques and processes herein, implementations herein are not limited to the particular examples shown and discussed.

### Example Architectures

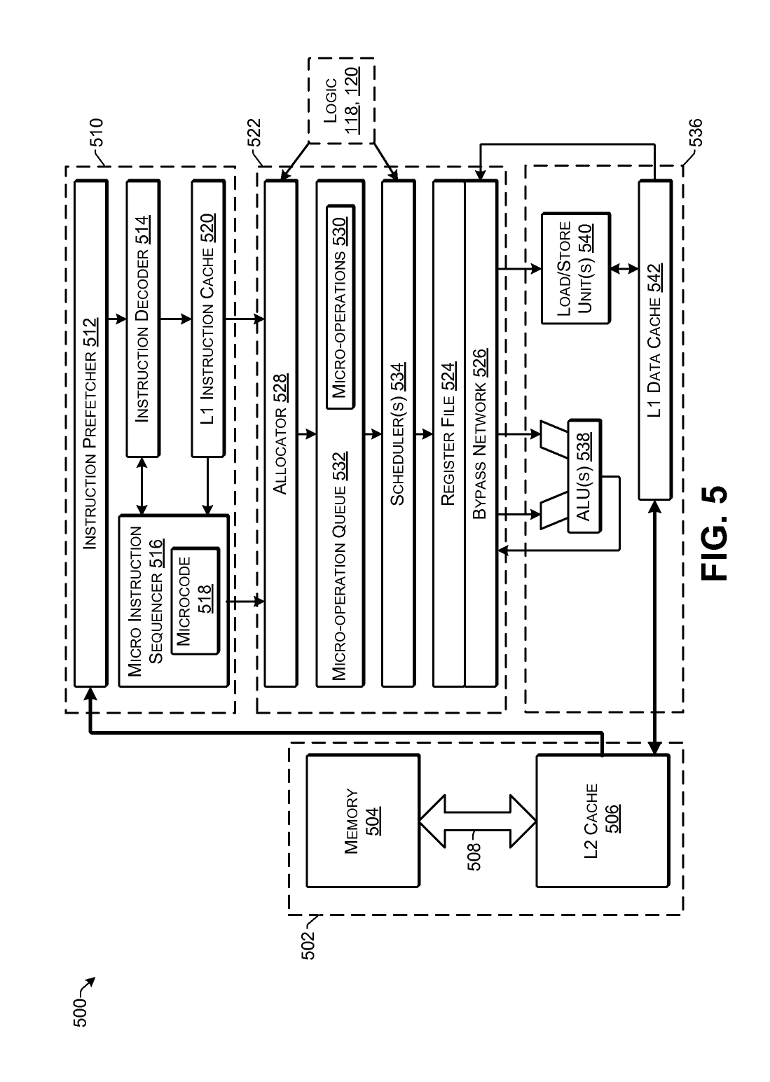

FIG. 5 illustrates a nonlimiting example processor architecture 500 according to some implementations herein that may perform later stage read port reduction. In some implementations, the architecture 500 may be a portion of a processor, CPU, or other digital processing apparatus and is merely one example of numerous possible architectures, systems and apparatuses that may implement the framework 100 discussed above with respect to FIG. 1.

The architecture 500 includes a memory subsystem 502 that may include a memory 504 in communication with a level two (L2) cache 506 through a system bus 508. The memory subsystem 502 provides data and instructions for execution in the architecture 500.

The architecture 500 further includes a front end 510 that fetches computer program instructions to be executed and reduces those instructions into smaller, simpler instructions referred to as micro-operations. The front end 510 includes an instruction prefetcher 512 that may include an instruction translation lookaside buffer (not shown) or other functionality for prefetching instructions from the L2 cache 506. The front end 510 may further include an instruction decoder 514 to decode the instructions into micro-operations, and a micro-instruction sequencer 516 having microcode 518 to sequence micro-operations for complex instructions. A level one (L1) instruction cache 520 stores the micro-operations. In some examples, the front end 510 may be an in-order front end that supplies a high-bandwidth stream of decoded instructions to an out-of-order execution portion 522 that performs execution of the instructions.

In the architecture 500, the out-of-order execution portion 522 arranges the micro-operations to allow them to execute as quickly as their input operands are ready. Accordingly, the out-of-order execution portion 522 may include logic to perform allocation, renaming, and scheduling functions, and may further include a register file 524 and a bypass network 526. In some examples, the register file 524 may correspond to the register file 102 discussed above and the bypass network 526 may correspond to the bypass network 116 discussed above. An allocator 528 may include logic that allocates register file entries for use during execution of micro-operations 530 placed in a micro-operation queue 532. For example, the allocator 528 may include logic that corresponds, at least in part to the logic 118 and the later stage read port reduction logic 120 discussed above. Accordingly, the allocator may allocate one or more read ports of the register file 524 for execution with a particular micro-operation 530, as discussed above with respect to the examples of FIGS. 1-4.

The allocator 528 may further perform renaming of logical registers onto the register file 524. For example, in some implementations, the register file 524 is a physical register file having a limited number of entries available for storing micro-operation operands as data to be used during execution of micro-operations 530. Thus, as a micro-operation 530 travels down the architecture 500, the micro-operation 530 may only carry pointers to its operands and not the data itself. In addition, the scheduler(s) 534 detect when particular micro-operations 530 are ready to execute by tracking the input register operands for the particular micro-operations 530. The scheduler(s) 534 may detect when micro-operations are ready to execute based on the readiness of the dependent input register operand sources and the availability of the execution resources that the micro-operations 530 use to complete execution. Accordingly, in some implementations, the scheduler(s) 534 may also incorporate at least a portion of the logic 118 and the later stage read port reduction logic 120 discussed above. Further, the logic 118, 120 is not limited to execution by the allocator 528 and/or the scheduler(s) 534, but may additionally, or alternatively, be executed by other components of the architecture 500.

The execution of the micro-operations 530 is performed by the execution units 536, which may include one or more arithmetic logic units (ALUs) 538 and one or more load/store units 540. The execution units 530 may employ a level one (L1) data cache 542 that provides data for execution of micro-operations 530 and receives results from execution of micro-operations 530. In some examples, the L1 data cache 542 is a write-through cache in which writes are copied to the L2 cache 506. Further, as mentioned above, the register file 524 may include the bypass network 526. In some instances, the bypass network 526 may be a multi-clock bypass network that bypasses or forwards just-completed results to a new dependent micro-operation prior to writing the results into the register file 524.

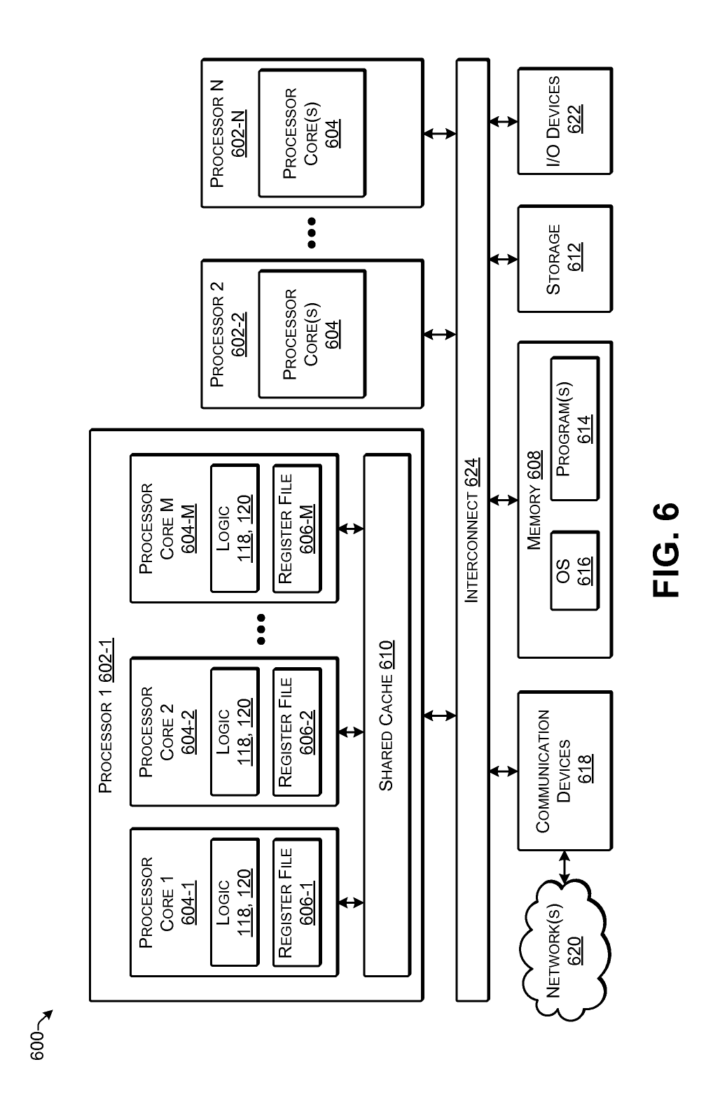

FIG. 6 illustrates nonlimiting select components of an example system 600 according to some implementations herein that may include one or more instances of the processor architecture 500 discussed above for implementing the framework 100 and pipelines described herein. The system 600 is merely one example of numerous possible systems and apparatuses that may implement later stage read port reduction, such as discussed above with respect to FIGS. 1-5. The system 600 may include one or more processors 602-1, 602-2, . . . , 602-N (where N is a positive integer≧1), each of which may include one or more processor cores 604-1, 604-2, . . . , 604-M (where M is a positive integer≧1). In some implementations, as discussed above, the processor(s) 602 may be a single core processor, while in other implementations, the processor(s) 602 may have a large number of processor cores, each of which may include some or all of the components illustrated in FIG. 5. For example, each processor core 604-1, 604-2, . . . , 604-M may include an instance of logic 118, 120 for performing later stage read port reduction with respect to read ports of a register file 606-1, 606-2, . . . , 606-M for that respective processor core 604-1, 604-2, . . . , 604-M. As mentioned above, the logic 118, 120 may include one or more of dedicated circuits, logic units, microcode, or the like.

The processor(s) 602 and processor core(s) 604 can be operated to fetch and execute computer-readable instructions stored in a memory 608 or other computer-readable media. The memory 608 may include volatile and nonvolatile memory and/or removable and non-removable media implemented in any type of technology for storage of information, such as computer-readable instructions, data structures, program modules or other data. Such memory may include, but is not limited to, RAM, ROM, EEPROM, flash memory or other memory technology. In the case in which there are multiple processor cores 604, in some implementations, the multiple processor cores 604 may share a shared cache 610. Additionally, storage 612 may be provided for storing data, code, programs, logs, and the like. The storage 612 may include solid state storage, magnetic disk storage, RAID storage systems, storage arrays, network attached storage, storage area networks, cloud storage, CD-ROM, digital versatile disks (DVD) or other optical storage, magnetic cassettes, magnetic tape, or any other medium which can be used to store desired information and which can be accessed by a computing device. Depending on the configuration of the system 600, the memory 608 and/or the storage 612 may be a type of computer readable storage media and may be a non-transitory media.

The memory 608 may store functional components that are executable by the processor(s) 602. In some implementations, these functional components comprise instructions or programs 614 that are executable by the processor(s) 602. The example functional components illustrated in FIG. 6 further include an operating system (OS) 616 to mange operation of the system 600.

The system 600 may include one or more communication devices 618 that may include one or more interfaces and hardware components for enabling communication with various other devices over a communication link, such as one or more networks 620. For example, communication devices 618 may facilitate communication through one or more of the Internet, cable networks, cellular networks, wireless networks (e.g., Wi-Fi, cellular) and wired networks. Components used for communication can depend at least in part upon the type of network and/or environment selected. Protocols and components for communicating via such networks are well known and will not be discussed herein in detail.

The system 600 may further be equipped with various input/output (I/O) devices 622. Such I/O devices 622 may include a display, various user interface controls (e.g., buttons, joystick, keyboard, touch screen, etc.), audio speakers, connection ports and so forth. An interconnect 624, which may include a system bus, point-to-point interfaces, a chipset, or other suitable connections and components, may be provided to enable communication between the processors 602, the memory 608, the storage 612, the communication devices 618, and the I/O devices 622.

For discussion purposes, this disclosure provides various example implementations as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A processor comprising:
a register file having a plurality of read ports to provide data during execution of a micro-operation, the micro-operation to utilize at least one first data source at least one pipeline stage earlier than at least one second data source;
first logic to detect, during a first pipeline stage, whether the at least one second data source is available from a bypass network; and
second logic to release, during a subsequent second pipeline stage, at least one read port allocated to the micro-operation when the at least one second data source is available from the bypass network.

2. The processor as recited in claim 1, further comprising third logic to identify the micro-operation as a type of micro-operation that employs at least two data sources.

3. The processor as recited in claim 1, further comprising third logic to, during the first pipeline stage, perform read port reduction with respect to the at least one first data source.

4. The processor as recited in claim 1, further comprising third logic to, during the second pipeline stage, obtain at least one operand corresponding to the at least one first data source.

5. The processor as recited in claim 1, further comprising third logic to, during a third pipeline stage, subsequent to the second pipeline stage:
start execution using the at least one first data source; and
receive an operand corresponding to the at least one second data source from the bypass network.

6. The processor as recited in claim 1, further comprising third logic to allocate the released at least one read port to be used during execution of a different micro-operation while the micro-operation is executed.

7. A method comprising:
allocating a number of read ports of a register file to execute a micro-operation that utilizes at least two data sources;
identifying at least one first data source of the micro-operation that is utilized during execution of the micro-operation before at least one second data source of the micro-operation is utilized;
performing, during a first pipeline stage, a bypass calculation to detect whether the at least one second data source is available from a bypass network; and
during a subsequent second pipeline stage, when the bypass calculation indicates that the at least one second data source is available from the bypass network, utilizing the at least one second data source from the bypass network to reduce the number of read ports allocated to execute the micro-operation.

8. The method as recited in claim 7, further comprising, during the first pipeline stage, performing read port reduction with respect to the at least one first data source.

9. The method as recited in claim 8, in which performing the read port reduction with respect to the at least one first data source comprises detecting, while the bypass calculation is being performed, whether a read port allocated to the at least one first data source is to be released for use by a different micro-operation.

10. The method as recited in claim 7, further comprising, during the second pipeline stage, obtaining at least one operand corresponding to the at least one first data source.

11. The method as recited in claim 7, further comprising during a third pipeline stage, subsequent to the second pipeline stage:
starting execution using the at least one first data source; and
receiving an operand corresponding to the at least one second data source from the bypass network.

12. The method as recited in claim 7, in which the first pipeline stage and the second pipeline stage correspond to sequential clock cycles of a system clock.

13. The method as recited in claim 7, in which the micro-operation is one of:
a fused-multiply-add (FMA) micro-operation;
a string-and-text-processing-new-instructions (STTNI) micro-operation; or
a dot-product-of-packed-single-precision-floating-point-value (DPPS) micro-operation.

14. The method as recited in claim 7, further comprising allocating at least one read port, released during the second pipeline stage, to be used during execution of a different micro-operation while the micro-operation is executed.

15. A system comprising:
a register file having a plurality of read ports to provide data during execution of micro-operations;
first logic to allocate at least three read ports to be available to maintain at least three operands for execution of a particular micro-operation, the particular micro-operation to utilize a first operand and a second operand of the at least three operands at least one clock cycle prior to utilizing a third operand of the at least three operands; and
second logic to perform read port reduction with respect to the third operand at least one clock cycle after performing read port reduction with respect to the first and second operands.

16. The system as recited in claim 15, further comprising third logic to perform a bypass calculation during a same clock cycle as performing the read port reduction with respect to the first and second operands.

17. The system as recited in claim 15, further comprising third logic to read at least one of the first or second operands from one of the register file read ports during a same clock cycle as performing read port reduction with respect to the third operand.

18. The system as recited in claim 15, in which the second logic to perform read port reduction comprises third logic to release a read port allocated to execute the micro-operation when a respective corresponding operand is available from a bypass network.

19. The system as recited in claim 18, further comprising fourth logic to allocate the released read port to be used during execution of a different micro-operation while the particular micro-operation is executed.

20. The system as recited in claim 15, further comprising:
a memory subsystem to provide instructions and data;
a front end to decode the instructions into a plurality of micro-operations including the particular micro-operation;
an out-of-order execution portion to include at least the first logic and the second logic; and
an execution unit to execute the plurality of micro-operations.
